(19) United States
(12) Patent Application Publication
(10) Pub. No.: US 2007/0276733 A1
(43) Pub. Date: Nov. 29, 2007

(54) Method and system for music information retrieval

(76) Inventors: Frank Geshwind, Madison, CT (US); Todd Carter, New York, NY (US)

Correspondence Address: FULBRIGHT & JAWORSKI, LLP, 666 FIFTH AVE, NEW YORK, NY, 10103-3198, US

(21) Appl. No.: 11/803,675

(22) Filed: May 14, 2007

Related U.S. Application Data
(63) Continuation-in-part of application No. 11/715,863, filed on Mar. 7, 2007.
Application No. 11/715,863 is a continuation-in-part of application No. 11/230,949, filed on Sep. 19, 2005.
Application No. 11/715,863 is a continuation-in-part of application No. 11/165,633, filed on Jun. 23, 2005.
(60) Provisional application No. 60/610,841, filed on Sep. 17, 2004.
(60) Provisional application No. 60/697,069, filed on Jul. 5, 2005.
(60) Provisional application No. 60/582,242, filed on Jun. 23, 2004.
(60) Provisional application No. 60/799,973, filed on May 12, 2006.
(60) Provisional application No. 60/799,974, filed on May 12, 2006.
(60) Provisional application No. 60/811,692, filed on Jun. 7, 2006.
(60) Provisional application No. 60/811,713, filed on Jun. 7, 2006.
(60) Provisional application No. 60/855,716, filed on Oct. 31, 2006.

(51) Int. Cl. G06Q 30/00

(52) U.S. Cl. 705/14

(57) ABSTRACT

Systems and methods are disclosed for searching or finding music with music, by searching, e.g., for music from a library that has a sound that is similar to a given sound provided as a search query, and to methods and systems for tracking revenue generated by these computer-user interactions, and for promoting music and selling advertising space. These include, inter alia, systems that allow a user to discover unknown music, and systems that allow a user to look for music based directly on queries formed from sounds that the user likes. In some embodiments these queries are comprised of a clip or relatively small segment of a larger media file. A client server system comprising web graphical elements, advertisements and/or other affiliated revenue links, elements in support of the music query and a music player, a database, elements for matching music clips to clips from a library, and elements to present results.

### RELATED APPLICATION

This application claims priority benefit under Title 35 U.S.C. § 119(e) of U.S. provisional patent application 60/799,973, filed May 12, 2006; U.S. provisional patent 60/799,974 filed May 12^{th}, 2006; provisional patent application 60/811,692, filed Jun. 7, 2006; provisional patent application 60/811,713, filed Jun. 7, 2006; and provisional patent application 60/855,716, filed Oct. 31, 2006, each of which is incorporated by reference in its entirety.

This application is also a continuation-in-part of U.S. patent application Ser. No. 11/715,863, filed Mar. 7, 2007, which is a continuation-in-part of U.S. patent application Ser. Nos. 11/230,949, filed Sep. 19, 2005 and 11/165,633, filed Jun. 23, 2005. U.S. patent application Ser. No. 11/230,949 claims priority benefit under Title 35 U.S.C. § 119(e) of provisional patent application 60/610,841, filed Sep. 17, 2004 and 60/697,069 filed Jul. 5, 2005. U.S. patent application Ser. No. 11/165,633 claims priority benefit under Title 35 U.S.C. § 119(e) of provisional patent application 60/582,242 filed Jun. 23, 2004. Each of the forgoing patent applications is incorporated herein by reference in its entirety.

### BACKGROUND AND FIELD OF THE INVENTION

The present invention relates to music information retrieval in general, and more particularly to systems and methods for searching or finding music with music, by searching, e.g., for music from a library that has a sound that is similar to a given sound provided as a search query, and to methods and systems for tracking revenue generated by these computer-user interactions. These include, inter alia, systems that allow a user to discover unknown music, and systems that allow a user to look for music based directly on queries formed from sounds that the user likes.

Today there is an abundance of music, and in particular digital music files. Indeed there are so many digital music files available to a listener today (many millions of files), that it is impossible for any one person to be familiar with all of the choices. In dealing with such a vast collection of media files, it is necessary to have automatic tools in order to assist users in finding what they want. Some prior art systems for search have been based on text and metadata (such as but not limited to artist names, track names, albums, years, genres, music review text, etc). These systems fall short in that they can only index media that have been described by these meta-tags, and this is a labor intensive process when required for a large library of media files. Additionally, the metadata does not fully characterize the sound of the music, and so the searches fall short in many respects when a user is looking for a particular “sound” or “feel” of the music in any but the coarsest of senses (i.e., a particular artist or genre can be found, but one has difficulty, for example, finding music that contains sounds similar to the guitar solo in a particular recording that the user has on his computer).

Some related and prior art systems for music information retrieval are based on collaborative filtering wherein data about user's tastes and preferences are mined for recommendations to provide to other users with similar tastes. One example is U.S. Pat. No. 5,790,426, which is incorporated herein by reference in its entirety. Purely collaborative filtering systems fail to directly take into account the sound of the music, and therefore, for example, can not be applied to new music for which user preference data is not yet available, nor can such systems be well applied to less popular music for which insufficient usage data is available. While collaborative filtering can be used in conjunction with the methods and systems disclosed herein, these related art system directed to collaborative filtering does not teach, nor contemplate the present invention as described herein.

Some related art systems are based on musical audio features, or are content based. These typically characterize the digital signals that comprise the music tracks, and relate to the whole music track. For example, U.S. Pat. No. 7,081,579, which is incorporated by reference in its entirety, recites “determining an average value of the coefficients for each characteristic from each said part of said selected song file.” It calls for utilizing a whole-music-track characterizing technique, wherein the system parameters are averaged to characterize an entire music track. Such systems have several disadvantages. Typically the features available to practitioners today do not fully capture the richness of human perception of media. Also, it is often beyond the capacity of currently available algorithms to fully characterize and represent the complexity of characterization of an entire media track, song, performance or program. Indeed, for example, entire songs have a variety of subjective “characters,” sounds or subjective qualities, as the song evolves in time, and the prior-art algorithms fail to adequately capture this. For this reason, the present invention relates in part to the use of “clips” (sub-portions of the media files)—smaller sections of media files that are statistically more likely to have a single “character” or sound or quality. Some related art systems use, for example, excerpted music clips (sub-portions of the whole track) for audio summarization. This allows users to browse collections and hear portions of the track(s) without taking the time to hear the whole track. But these systems do not teach using these clips for searching, active learning or query refining in accordance with an embodiment of the present invention.

In this regard, the present invention relates to finding music based on the sound of segments of music taken from a possibly larger piece of music. Present-day text-based information retrieval is largely based on the notion of a “key word”. Typically, text-based information retrieval systems provide a means for users to search for documents that contain a particular word or phrase. In accordance with an embodiment of the present invention, the system and method provides ways for users to search for music based on “key sounds” analogous to key words. Of course, just as more complex text-based queries can be built by combining key words, Boolean operators and the like, complex queries can be generated by combining clips and other information in accordance with an embodiment of the present invention. Some related art systems discuss the generation of complex music information retrieval queries. For example, U.S. Pat. No. 6,674,452, which is incorporated herein by reference in its entirety, describes a Graphical User Interface for building complex music information retrieval queries by combining elements of a query. Also a use of music “segmentation” is discussed in U.S. Pat. No. 5,918,223, which is incorporated herein by reference in its entirety, and which describes systematic splitting of music files into smaller pieces for analysis, primarily to combine the results of such splitting by averaging the data. It also describes using the segmented data on a predetermined library of music in order to characterize segments within the predetermined library. U.S. Pat. No. 7,081,579 also discusses “section processing” in which a single representative segment is selected for music in a predetermined library, by comparing each segment to the averaged track. While elements of these related systems can be used in conjunction with the methods and systems of the present invention, these related art system do not teach, nor contemplate the present invention, including but not limited to the way in which clips are used to specify and refine queries and the way data is indexed and searched in the database and the way in which results are provided.

Additionally, the present invention relates in part to more efficient ways of performing content based searches. Indeed a very large database can be required in order to systematically catalog sounds within pieces of music, over a possibly large library of music—larger, a priori, than the database required to catalog a single sound summary for each piece of music. In this regard the present invention relates to methods for using content based features and approximate similarity techniques, such as but not limited to approximate nearest neighbor algorithms and locality sensitive hashing to efficiently store and index information about a library of music, and efficiently search through this index.

Some references discuss the use of relevance feedback, active learning and machine learning within the context of music information retrieval. For example, M. Mandel, G. Poliner, and D. Ellis. “Support Vector Machine Active Learning for Music Retrieval.” ACM Multimedia Systems Journal, Volume 12, Number 1: Pages 3-13, 2006, and “Song-level Features and Support Vector Machines for Music Classification”, In Proc. International Conference on Music Information Retrieval (ISMIR), pages 594-599, London, 2005, each of which is incorporated herein by reference in its entirety. While elements of these references can be used in conjunction with the methods and systems disclosed herein, these references do not teach, nor contemplate the present invention, including but not limited to the way in which clips are used to specify queries, data is indexed and hashed, and searches are conducted on the database.

There are related art systems and methods for computing audio features from digital audio signals. Some use Fourier transforms and related techniques including but not limited to cepstral and Mel-frequency cepstral coefficients. The features are of interest in characterizing audio signals but spectral information alone often does not provide a sufficiently powerful representation of audio data for the areas of application within the scope of the present invention.

Others related art techniques additionally capture temporal and “sound texture” aspects of sound, such as M. Athineos and D. P. W. Ellis, Sound texture modeling with linear prediction in both time and frequency domains, in Proc. ICASSP, 2003, vol. 5, pp. 648-651, and M. Athineos and D. Ellis, Frequency-domain linear prediction for temporal features, In Proc. IEEE Automatic Speech Recognition and Understanding Workshop (ASRU), pages 261-266, St. Thomas, 2003 (See, http://www.ee.columbia.edu/˜dpwe/pubs/asru03-fdlp.pdf each of which is incorporated herein by reference in its entirety. These various related art references do not teach using audio clips to specify and refine queries and perform searches in accordance with an embodiment of the present invention.

Disadvantages of these related art systems arise from the fact that a user can't describe what she doesn't know and that a track has more than one “sound”—a user's interest in a track is not specific enough to disambiguate the query. Hence these related art systems leave something to be desired in terms of providing systems that allow a user to, discover unknown music, and look for music based directly on queries formed from sounds that the user likes.

Additionally, the present invention relates in part to methods and systems for choosing and displaying advertisements in connection with music search, discovery and recommendation. Related art systems exist for displaying advertisements in connection with search results, such as U.S. Pat. No. 6,269,361, which is incorporated herein by reference in its entirety, and which describes a system for influencing the position for a search listing within a search result list generated by an Internet search engine, based on search terms comprising one or more keywords. Just as the present invention relates in part to searching for music based on the sound features of the music, it analogously relates to influencing the position for a search listing within a search result list generated by an Internet search engine, based on search terms comprising one or more music features—something which the related art does not teach nor contemplate.

For the forgoing reasons, there is a need for improved systems and methods for music information retrieval that provide for searching or finding music with music, by searching for music from a library that has a sound that is similar to a given sound provided as a search query, and in particular when this search query is comprised of a clip or relatively small segment of a larger media file.

### OBJECT AND SUMMARY

It is an object of the present invention to provide systems and methods and an improved user interface and user experience for finding new music based on an automatic comparison between the sound of the new music, and the sound of music that the user already has or already knows about.

With regard to the user interface and user experience, in accordance with an embodiment of the present invention this is accomplished in part by a web-based client server system with an interface comprising a query specification section and a query result section. The query specification section is comprised of a drag-and-drop and/or open-file sub-window of the interface, wherein music files from the user's computer can be “dragged” to the sub-window, and “dropped” onto the sub-window. In this way, a query is specified using familiar computer mouse gestures. Of course drag-and-drop, and file open dialog boxes are but two techniques for specifying input data, and these are used here for purposes of illustration and are not meant to limit the scope of the present invention. Embodiments of the present invention can be additionally comprised of interface elements to play the query sound file, to select one or more sub-clips of the query file, and to select additional search filters and/or other search query refinement data.

With regard to finding music based on the sound of the music, in accordance with an embodiment of the present invention this is accomplished by the interface, system and method described herein. More particularly, in accordance with an embodiment of the present invention, a web site comprises a web server with web pages and files including client application code and server code, databases, and other components, each as described herein and additionally comprising those standard elements of a web server, known to those of skill in the art. The client application provides an interface allowing a user to specify a first audio clip (the query). The query clip is comprised of one or more clips, segments or time windows of sound taken from a potentially larger music, sound, audio or media file. In some embodiments this larger music file is specified and supplied from the user's computer, and/or from a library of music files on the web server, and/or from third-party music collections and/or servers. This query clip is processed by the client application to produce a characteristic set of query sound features. The query sound features are passed to the server by the client application. The server additionally comprises a database of sound features for a large library of music clips. The server processes the query sound features by searching the database to find those music clips that are closest to or match the query sound features. References to the resulting/corresponding music files (the query results) are passed back to the client application. The client application displays the query results. In some embodiments the client is additionally comprised of components that allow the user to do one or more of: play back or preview the sound clips corresponding to the results, refine the query results, get additional information related to the results, conduct new queries, download one or more results, label or tag, rate or review one or more results, share one or more results, create a new musical composition comprising one or more results, purchase copies of the music files returned, generate and purchase ringtones and purchase other merchandise associated or affiliated with the results.

It is an object of the present invention to provide for improved music information retrieval by using short music clips as query and result objects, rather than using entire music “songs” or “tracks”, and to improve such information retrieval further by improved methods and systems for the determination of music similarity and affinity. This is accomplished in part by computing music features in accordance with embodiments of the present invention as described herein.

It is an object of the present invention to provide for a personalized music filtering system that recommends music for users. To specify their musical preferences, users select one or more sound clip examples from one or more sources including but not limited to the user's personal library, and/or search results from embodiments of the present invention. Sound features from this collection of music clips are generated in accordance with the methods disclosed herein. These sound features are used to filter sets of music, audio tracks and/or clips to create search results for the user. These results are generated and presented as a personalized search in accordance with the search and recommendation system disclosed herein. The filter is used to generate a live feed of new music that is of potential interest to the user in accordance with an embodiment of the present invention. To that end, the present invention in accordance with an embodiment comprises a system for receiving, processing and storing new music files from one or more new music file providers, a system for filtering this collection of new music files to determine a subset of the new music files estimated to be of interest to a user in accordance with the filter as described herein, and a system for providing the results of such a process to the user that could include, but is not limited to, XML feeds standard in the art such as RSS or ATOM feeds, or, for another example, by periodic or real-time email alerts to the user(s) as soon as new music is encountered that is deemed to be of interest to the user.

It is an object of some embodiments of the present invention to provide for improved music information retrieval using relevance feedback wherein, after a first query is executed and the user's results are returned, the user provides feedback about the relevance of the results returned. This feedback is then used to refine the results by conducting a modified query. Such refinement and creation of modified queries is accomplished in accordance with the present invention by the methods and systems disclosed herein, and in part using the methods and systems disclosed in the U.S. patent application Ser. No. 11/230,949, filed Sep. 15, 2005, Geshwind et. al., System and Method for Document Analysis, Processing and Information Extraction, which is incorporated herein by reference in its entirety.

Certain prior art systems use whole songs to seed the search or, e.g., the relevance feedback process. Since it takes a significant amount of time to listen to each sound, audio or media file and since a user may be subjectively interested in a particular sound or sounds associated with one or more of the media files, the methods and systems disclosed herein are used in some embodiments to streamline a search, active learning or query refinement process by minimizing the amount of time and the number of examples that a user must label for a query.

By allowing users to segment and directly specify the actual sounds that comprise the search query this process also leads to increased relevancy of results returned from a search or filtering process.

It is an object of the present invention to efficiently search through a large library of music clips to find matches that have features similar to a target clip's features. This is accomplished in some embodiments by locality sensitive hashing (see, for example, the paper by Indyk, P., Motwani, R. 1998, titled “Approximate nearest neighbors: towards removing the curse of dimensionality,” published in 1998 in the Proceedings of 30th STOC, pages 604-613), in which the values of certain hash functions related to the feature vectors of the clips are used as indexes to pre-search from the large library, thereby producing a smaller set of clips that can be compared to the target clip and, for example, sorted according to the feature vector distance between the clip's features and the target clip's features, as described in more detail herein.

In accordance with an embodiment of the present invention, a computer based method for searching a music library comprises the steps of receiving an audio clip from a user; computing musical features of the audio clip; transmitting the musical features of the audio clip to a server; and receiving a segment of a music file from the server determined to be similar to the audio clip by comparing the musical features of the audio clip to musical features associated with segments of a plurality of music files stored in the music library to find the segment from the segments of the plurality of music files stored in the music library that is similar to the audio clip.

In accordance with an embodiment of the present invention, a system for searching a music library comprises a music library and a client device connected to a server over a communications network. The music library comprises a plurality of music files and a plurality of musical features associated with segments of the plurality of music files. The client device, associated with a user and connected to a communications network, selects an audio clip, plays said audio clip and computes music features of the audio clip. The server receives the musical features of the audio clip from the client device over the communications network and compares the musical features of the audio clip to the musical features stored in the music library to find a segment from segments of the plurality of music files that is similar to the audio clip.

In accordance with an embodiment of the present invention, a computer medium comprises a code for searching a music library. The code comprises instructions for: receiving an audio clip from a user; computing musical features of the audio clip; transmitting the musical features of the audio clip to a server; and receiving a segment of a music file from the server determined to be similar to the audio clip by comparing the musical features of the audio clip to musical features associated with segments of a plurality of music files stored in the music library to find the segment from the segments of the plurality of music files stored in the music library that is similar to the audio clip.

In accordance with an embodiment of the present invention, the present invention accepts input music and/or audio clip in a set of predetermined formats which can include, without limitation, music formats known in the art such as WAV, MP3, and AAC formats. For any such formats that are encoded or compressed, the embodiment is additionally comprised of a suitable decoder/decompression element for decoding/decompressing the input audio into raw digital audio samples.

In accordance with an embodiment of the present invention, advertisements are accepted from advertisers and are selected for display along with music search, discovery and recommendation results. Advertisers can be but are not limited to music owners, publishers or artists. Advertisers are provided with a system in accordance with an embodiment of the present invention, in order to specify music content and other advertising that the advertisers wish to promote in specified contexts. The system is comprised of an interface that allows the advertiser to specify this context by associating music features with advertisements. The context occurs in an embodiment of the present invention, when the music features associated with an advertisement are sufficiently similar to music features corresponding to a search query. Associated databases to track these specifics, to record the display of the advertisements and other associated events such as but not limited to clicking by the user on the advertisements, user account and billing information, are provided in accordance with an embodiment of the present invention. In accordance with the present invention the advertisements are displayed when the associated data arises in connection with a user conduction a query using the systems described herein, wherein the data matches the data associated with the advertisement including but not limited to the sound of specified music and/or other music metadata associated with the advertisements as described herein.

In accordance with an embodiment of the present invention, a computer based method for selecting and displaying advertisements comprises the steps of receiving an audio clip from a user; computing musical features of the audio clip and transmitting the musical features of the audio clip to a server. The computer based method further comprises the step of receiving a set of advertisements from the server determined to be relevant in the context of the audio clip by comparing the musical features of the audio clip to musical features stored in a database and associated with a plurality of advertisements stored in the database to find the set of advertisements from the database that is determined to be relevant in the context of the audio clip.

In accordance with an embodiment of the present invention, a system for selecting and displaying advertisements comprises a client device, a server and a database. The client device, associated with a user and connected to a communications network, receives an audio clip from the user and computes musical features of said audio clip. The server receives the musical features of the audio clip from the client device over the communications network. The server determines a set of advertisements to be relevant in the context of the audio clip by comparing the musical features of the audio clip to musical features stored in a database and associated with a plurality of advertisements stored in the database to find the set of advertisements from the database that is determined to be relevant in the context of the audio clip. The server transmits the set of advertisements to the client device over the communications network.

In accordance with an embodiment of the present invention, a computer medium comprises a code for selecting and displaying advertisements. The code comprises instructions for receiving an audio clip from a user, computing musical features of the audio clip, transmitting the musical features of the audio clip to a server, and receiving a set of advertisements from the server determined to be relevant in the context of the audio clip by comparing the musical features of the audio clip to musical features stored in a database and associated with a plurality of advertisements stored in the database to find the set of advertisements from the database that is determined to be relevant in the context of the audio clip.

While embodiments of the present invention are described in terms of searching for/finding/retrieving of music, one of skill in the art will readily see that other embodiments can be implemented in a straightforward way, that allow for similar searching, etc, of other media (such as images, videos, text, multimedia documents and the like).

### BRIEF DESCRIPTION OF THE DRAWINGS

The present invention will be understood and appreciated more fully from the following detailed description, taken in conjunction with the drawings in which:

FIG. 1 shows an example of a query user interface in accordance with an embodiment of the present invention;

FIG. 2 shows a “swimlane” diagram of the flow of user/client/server interaction in accordance with an embodiment of the present invention;

FIG. 3 shows a high-level client side block diagram in accordance with an embodiment of the present invention;

FIG. 4 shows a block diagram of a client-side clip selection and playback system in accordance with an embodiment of the present invention;

FIG. 5A shows a block diagram of a clip feature vector calculation system in accordance with an embodiment of the present invention;

FIG. 5B shows a block diagram of normalized spectral feature computation in accordance with an embodiment of the present invention;

FIG. 5C shows a block diagram of normalized temporal feature computation in accordance with an embodiment of the present invention;

FIG. 6 shows a block diagram of a system for building a server-side clip feature vector database in accordance with an embodiment of the present invention;

FIG. 7 shows a block diagram of hash function computation in accordance with an embodiment of the present invention;

FIG. 8 shows a block diagram of query/result information retrieval in accordance with an embodiment of the present invention; and

FIG. 9 shows an exemplary screen shot of a query+result user interface in accordance with an embodiment of the present invention, comprising query results, playback/preview elements, additional clip information elements, query refinement elements, and links to advertisements and affiliated products and services.

FIG. 10 shows a block diagram of a lyrics search embodiment in accordance with the present invention.

FIG. 11 shows a block diagram of an advertising customer interface in accordance with an embodiment the present invention.

FIG. 12 shows a block diagram of a search and advertising system and method embodiment in accordance with the present invention.

### DETAILED DESCRIPTION OF THE EMBODIMENTS

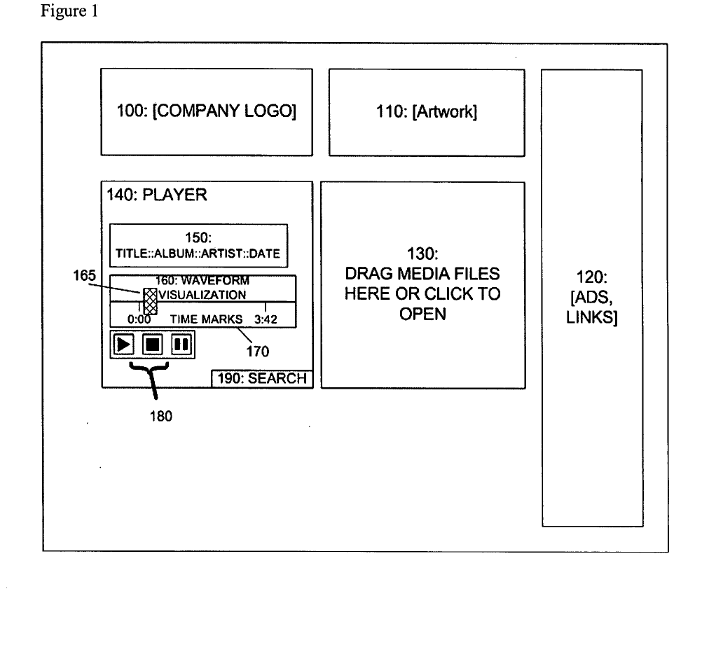

Turning now to the drawing figures and particularly FIG. 1, an embodiment of the present invention comprises a web page with typical graphical elements such as a company logo (100), other decorative artwork (110), a section of the page for advertisements or other affiliated revenue links (120), and elements in support of the music query comprising a query file select sub-window (130), and a query file player (140) comprising title, artist, album, track information (150), audio waveform plot (160) with selected clip window (165), time marks (170), player controls such as start, pause and stop (180), and a search button (190).

Use of the webpage comprises viewing the page, selecting one or more files from the user's computer, requesting a query and examining the results. Selecting a music file comprises selecting a music file by operation in which a music file from the user's computer is dragged and dropped on the file select sub-window (130). Alternatively, or in addition, the sub-window can have the behavior that when it is clicked, a file-open dialog is launched on the user's computer for specification of a music file. Once selected, the client application computes a visualization of the music file, such as an audio waveform plot (160), and this is displayed along with artist/title/track/album information (150), and time marks (170). The file can begin to play when loaded, or the user can control the playback of the file by clicking the playback controls (180), which will cause the selected clip window to scroll to the right as the file plays. Additionally the selected clip window can be dragged by the user, with the mouse. When the user hears the desired clip of music from within the whole file, or wants to perform a search, the user clicks the search button (190), and the search is performed. At any time, the advertisements and affiliated revenue links can be updated in accordance with methods known to those of skill in the art and/or methods such as those disclosed in U.S. patent application Ser. No. 11/230,949. In particular, these links can be updated to reflect those advertisements that are most relevant to the search query or result files. At any time, the user can click on a link from these advertisements or affiliate links.

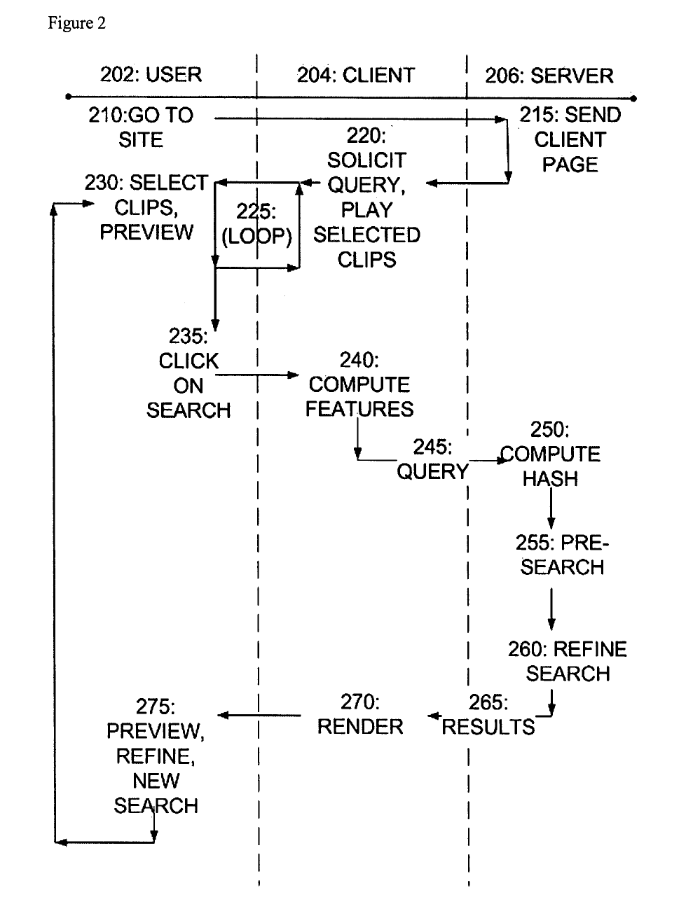

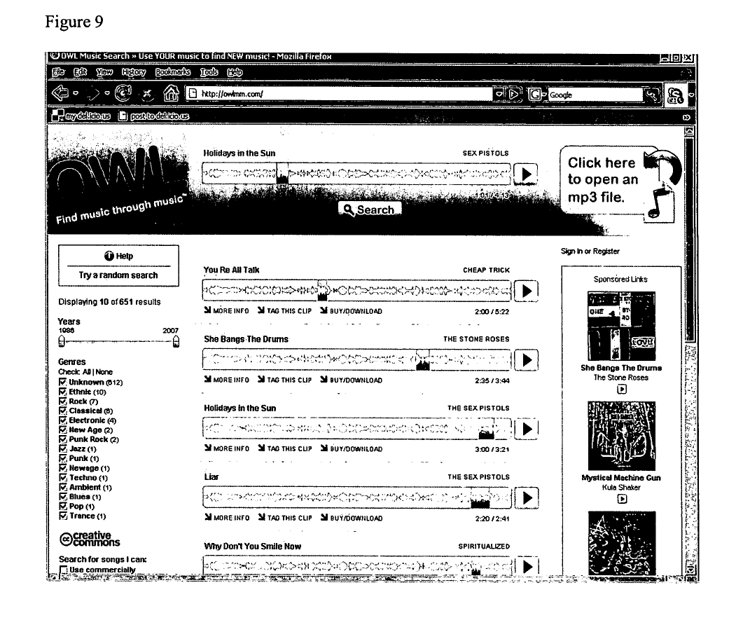

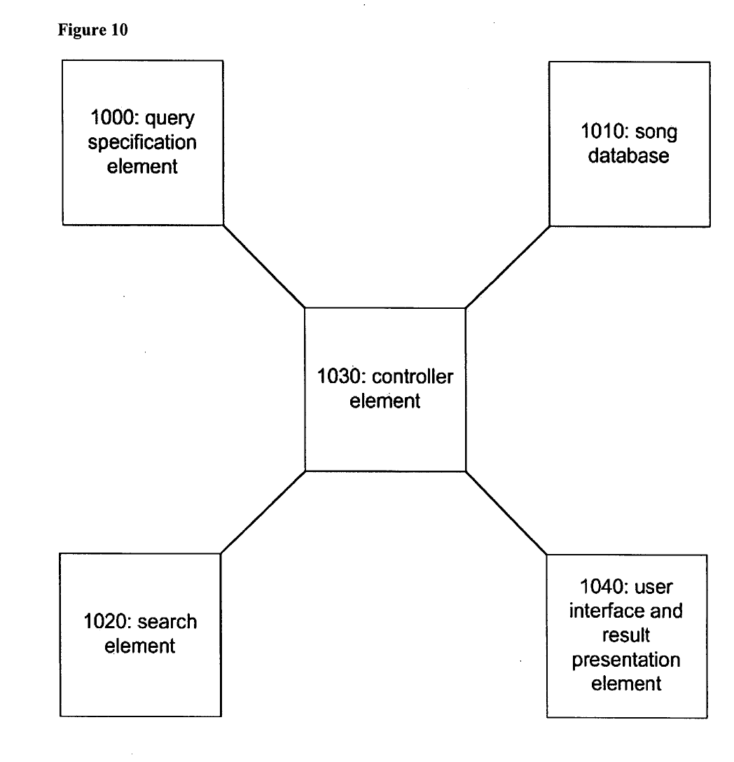

FIG. 2 shows a flow diagram of the interaction between a user (202), the client application (204) and the server application (206) in accordance with an embodiment of the present invention. In step 210, the user goes to the website of the service provider practicing the present invention. The server (206) sends webpages comprising the client application (204) to a computing device associated with the user. In steps 220-235, the client application (204) then renders an interface such as one shown in FIG. 1, and interaction follows such as but not limited to the interaction described with respect to FIG. 1. This is shown in FIG. 2 as a loop 225, wherein the client application (204) solicits a query in step 220, the user (202) selects one or more files from the user's computer in step 230, the user clicks buttons on the client application (204) so as to preview the selected files, and move around the selection window. The loop exits when the user (202) clicks on the “search” button in step 235. The client (204) computes features from the clip comprising the selected window in step 240, and sends a query comprising these features to the server (202) in step 245. The server (206) calculates hash function scores for the query sent in step 250, performs a pre-search based on has function matching in step 255, and then performs a refined search based on, for example but not limited to, Euclidean norm distance of music features restricted to the subset of matches from the hash function pre-search in step 260. The refined search can be based on other similarity measures including but not limited to diffusion distance as described in the references cited herein. The server (206) then sends music tracks and clips corresponding to the refined search results to the client application (204) in step 265. In some embodiments, what is actually sent to the client (204) is metadata comprising one or more of: graphical and textual representations of the matching music files, offsets into the files for the matching clips, other metadata such as album art, artist, title, album and track information, genre information, year of release, album reviews etc. The client (204) renders the search results, for example but not limited to doing so according to the interface shown in FIG. 9 in step 270, and the user (202) previews the resulting tracks and clips, refines the search query and/or performs a new query in step 275. Again, it is appreciated that the user (202) is free to click on advertising or affiliate links at any time.

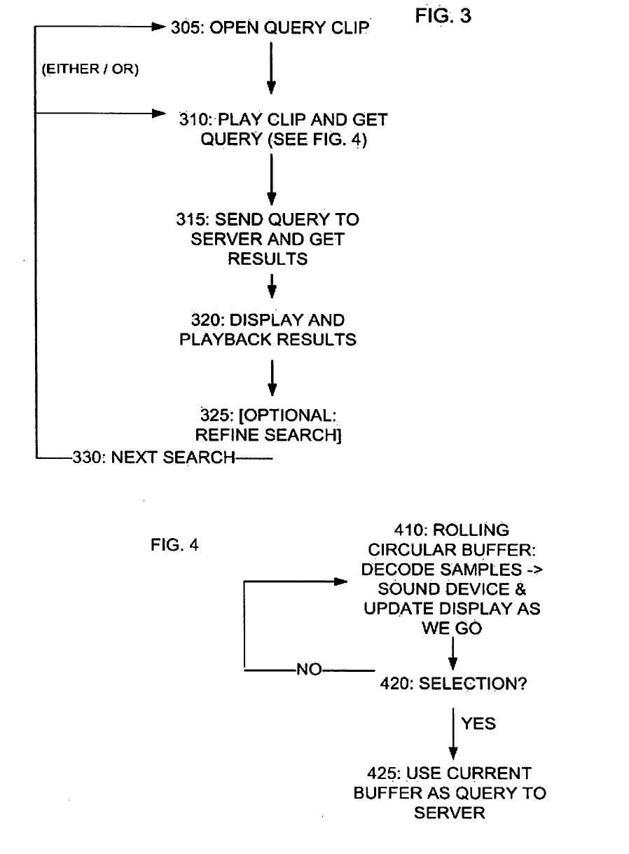

FIG. 3 shows a high-level client side block diagram in accordance with an embodiment of the present invention. A user (202) opens a query file on the user's computer in step 305, via the client application (204). The file is played and a selection is made, generating a query request in step 310. The query is comprised of the clip features as described herein.

FIG. 4 shows some details of this clip selection process in accordance with an embodiment of the present invention. As shown in step 410, as the file is played, a circular buffer is kept. This buffer holds the decoded sample values of the music (e.g., PCM samples), for a fixed time window such as 10 seconds. As the file is played, a predetermined sized window, such as a ten second window advances by one second of music file for every one second of real time. This repeats until the user hits the search button (or, e.g., manually grabs and drags the selection window) in step 420. Once a search is requested, the current buffer is used to generate a search query vector in accordance with an embodiment of the present invention in step 425.

Returning to FIG. 3, the results of the query are sent from the server (206) to the client (204) in step 315. The results are displayed on the user's computer in step 320, optionally the user (202) creates a refined query request in step 325, and the process is repeated either with a whole new query, or with a refined query in step 330. In some embodiments, users (202) can use a clip from any one of the result tracks of the first query as a seed (i.e., a selected clip) for a new query.

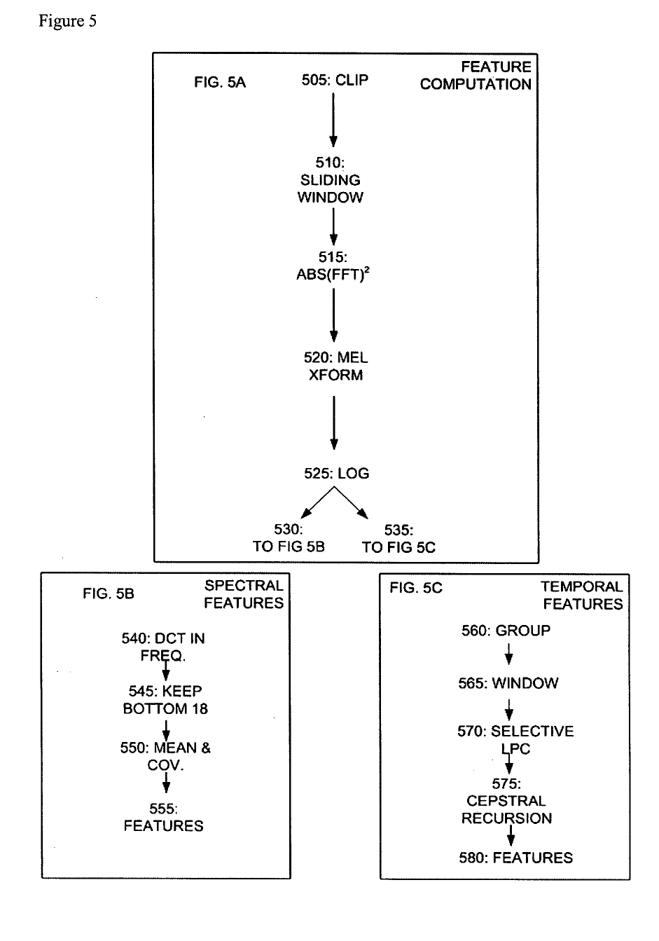

FIG. 5A shows a block diagram of a clip feature vector calculation system in accordance with an embodiment of the present invention. A clip (for example a 10 second clip, sampled at, e.g., 44 kHz in stereo, and taken as a window from a larger music file), is used as a query seed in step 505. A short-time Fourier transform (STFT) is computed by sliding a window over the clip (i.e., a window of predetermined length (e.g., 25 ms) in step 510, shifted by a predetermined series of offsets (e.g., 10 ms)), and the absolute value squared of the FFT of each of these sliding windows is computed to get the STFT (e.g., those could be a 512 by 1000 matrix of numbers, with 512 frequency bins, and 1000 time samples, just as one example) in step 515. A Mel-filter spectral weighting is applied (e.g., this can reduce, e.g., the 512 frequency samples per time bin to, say, 40 frequency bins) in step 520, and a logarithm is taken in step 525. This produces the Mel-Table. The results are further processed to produce spectral features as shown in FIG. 5B, and temporal features as shown in FIG. 5C.

FIG. 5B shows a block diagram of normalized spectral feature computation in accordance with an embodiment of the present invention. The Mel-Table generated from the process depicted in FIG. 5A is used compute spectral features. A DCT in frequency (for each time bin) is computed in step 540, and the 18 lowest-frequency samples are kept in step 545. The mean and covariance of these 18-dimensional vectors, over the set of time bins, is computed in step 550. This results in 189 features (comprising the lower-triangular part of the covariance matrix and resulting in 171 features, since

$$171 = \frac{18 ⨯ 19}{2} ,$$

plus the mean vector of 18 features) in step 555. It is appreciated that the number 18 in this paragraph is simply a parameter, and while it is used in some embodiments, it is meant to be illustrative and not limiting. Hence the numbers 171 and 189 can or will likely change in some embodiments.

FIG. 5C shows a block diagram of normalized temporal feature computation in accordance with an embodiment of the present invention. The Mel-Table generated from the process depicted in FIG. 5A is used compute temporal features. The 40 Mel frequency bins are combined into 4 bins in step 560. The lowest frequency Mel-Table row is kept as the lowest frequency row. The next 13 rows are averaged one row, and the next 13 after that into another, and the top 13 into the final or top row of the grouped table. Using the illustrative numbers from above, this results in a 4 by 1000 matrix. Each row of this matrix is multiplied by a fixed window function in step 565. A selective Linear Prediction (LP) also known as selective Autoregressive Modeling (AR) is then performed, (for example to produce a 4×48 matrix of 4 sets of LP coefficients) in step 570. Cepstral recursion is applied to the LP coefficients in step 575, which ultimately results in 192=4*48 features in step 580. Selective Linear Prediction as used herein refers to the pseudo-autocorrelation calculated by inverting only part of the power spectrum. In comparison, standard autocorrelation is calculated by inverting the full power-spectrum. Once again for emphasis, the specific numbers used (such as 40 Mel frequency bins, combined into 4 bins and resulting in 192=4*48 coeffecients) is presented here for illustrative purpose only and in other embodiments other choices can be made.

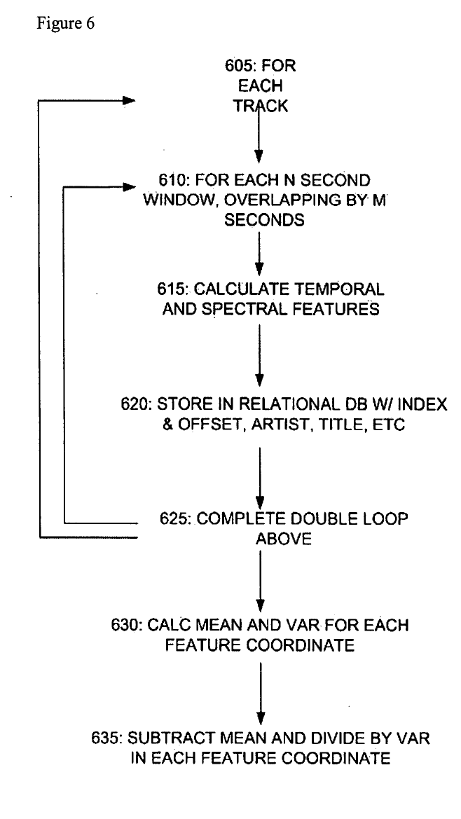

FIG. 6 shows a block diagram of a system for building a server-side clip feature vector database in accordance with an embodiment of the present invention. Given a fixed window length N (e.g., N=10 seconds), and a desired window shift M (e.g., M=5 seconds), the algorithm shown loops over each track in a library in step 605, and a series of clips of length N seconds, with M second shifts in step 610. That is, for each track, a sequence of N second clips is produced by taking as a window the first N seconds of the then current track, and then shifting the window by M seconds to get the next window, etc. For each such window, the temporal and spectral features are calculated in step 615, for example but not limited to the methods shown in FIGS. 5A, 5B, and 5C. These features are stored in a relational database along with track and offset identification/index information, and other track metadata such as artist, title, album, genre, recording year, publisher, etc in step 620. This loop is completed over each specified window shift, and over each track in the library in step 625. Then, for each feature, the mean value and standard deviation of the feature is computed over the entire library in step 630. These values are used to normalize the data just computed, and are then stored for later use (since incoming query features will need to be normalized). The normalization consists of subtracting the mean and dividing by the standard deviation in step 635. That is, of the features computed are f_{i,j} when i indexes over the library of sub-track clips of length N seconds, and j indexes the features, then the means mⱼ=the mean of f_{i,j} over the first index, and standard deviations vⱼ=the standard deviation of f_{i,j} over the first index, are each computed. Then f_{i,j} is replaced by

$${\tilde{f}}_{ij} = \frac{{f}_{ij} - {m}_{j}}{{v}_{j}} .$$

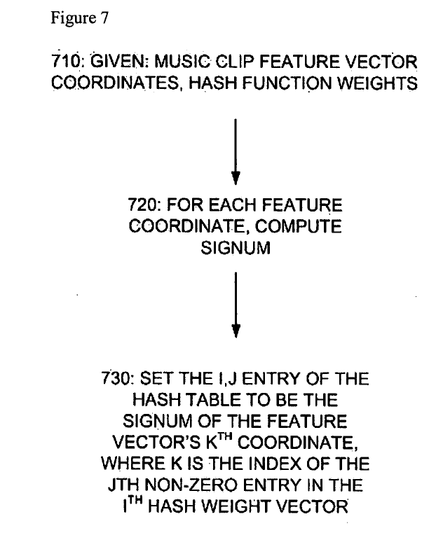

FIG. 7 shows a block diagram of a hash function computation in accordance with an embodiment of the present invention. In step 710, the present system is given music clip feature vector coordinates fⱼ, and hash weights Cᵢⱼ, i=1 . . . L where L is the desired number of hash functions (a predetermined parameter of the algorithm), and j=1 . . . M, with M=# of features, such that each entry of Cᵢⱼ is either 0 or 1, and the sum of Cᵢⱼ over j is equal to a fixed constant K (a parameter of the algorithm). In step 720, the present system computes the signum by assigning sⱼ=1 if fⱼ>0, and sⱼ=0 otherwise. In step 730, for i=1 . . . L, the present system sets or assigns find(i) to be the set of all j such that Cᵢⱼ=1 (find(i)={j|Cᵢⱼ=1}), and find(i, j)=the j^{th} smallest element of the set find(i) (which has K elements by construction), for i=1 . . . L and j=1 . . . K. Finally define Hash(i,j)=s(find(i,j)), i=1 . . . L, j=1 . . . K, which is the output hash table or hash function for the input clip feature vector coordinates fⱼ. Other hashing schemes are possible including without limitation those described in the literature cited herein. In particular, the values Cᵢⱼ need not be restricted to be 0,1.

In accordance with an embodiment of the present invention, the hash function above is computed for the normalized clip feature vectors \tilde{f}ᵢⱼ, and the hash table for each clip stored as an additional field in the relational database described herein.

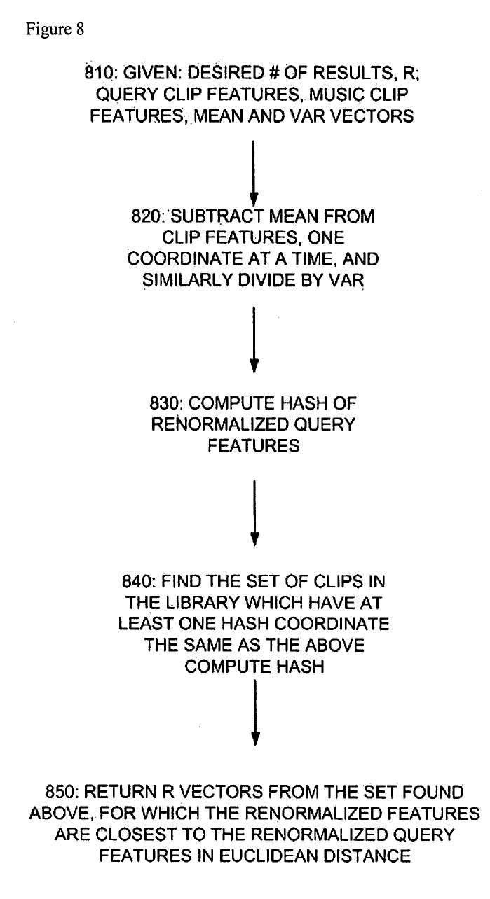

FIG. 8 shows a block diagram of query/result information retrieval in accordance with an embodiment of the present invention. Given a desired number of results R, query clip features fⱼ, j=1 . . . M, music clip library features \tilde{f}ᵢⱼ, and mean and variance vectors mⱼ and vⱼ as described herein in step 810, the present invention computes,

$${\tilde{f}}_{j} = \frac{{f}_{j} - {m}_{j}}{{v}_{j}} , for j = 1 … M$$

in step 820. The present invention computes the hash of renormalized query features in step 830 by letting QueryHash(i,j)=the hash table for the coordinates \tilde{f}ⱼ, and Hash(k,i,j)=the hash table for clip #k from the library. The present invention finishes the set of clips in the library which have at least one hash coordinate in step 840 by letting Lᵢⱼ={k Hash(k,i,j)=QueryHash(i,j)}, and let L=the union of the Lᵢⱼ. That is, the set L of those music clips whose hash table agrees with the hash table of the query clip, for at least one row of the table is formed. The query result is returned in step 850, which consists of the R closest music clips from within the set L, where the notion of closest is, for example but not limited to, in the sense of Euclidean distance. In other embodiments other distance functions can be used including without limitation diffusion distance as taught in the cited references.

The musical features described herein are meant to provide an embodiment of the present invention and are not meant to limit the scope of the invention to such embodiment. Other musical features can be used in accordance with the present invention to characterize music similarity, including but not limited to features that relate to energy, percusivity, pitch, tempo, harmonicity, mood, tone and timbre, as well as purely mathematical features including but not limited to those derived by combinations of Fourier analysis, wavelet analysis, wavelet packet analysis, noiselet analysis, local trigonometric analysis, best basis analysis, principle component analysis, independent component analysis, single scale and multiscale diffusion analysis, and such other techniques as are known or become known to those of skill in the art.

FIG. 9 shows an example of a query+result user interface in accordance with an embodiment of the present invention, comprising query results, playback/preview elements, additional clip information elements, query refinement elements, and links to advertisements and affiliated products and services. The interface comprises the elements of the search interface shown in FIG. 1 such as a company logo (100), other decorative artwork (110), a section of the page for advertisements or other affiliated revenue links (120), and elements in support of the music query comprising a query file select sub-window (130), and a query clip player (140) comprising title, artist, album, track information (150), audio waveform plot (160) with selected clip window (165), time marks (170), player controls such as start, pause and stop (180), and a search button (190). Additionally, the interface comprises a series of result music clips comprising clip players information comprising title, artist, album, track information, audio waveform plots with selected clip windows, time marks, player controls such as start, pause and stop, search buttons, and additional search query refinement and filter elements such as, and optionally including but not limited to the genre and period controls shown in FIG. 9.

Use of the webpage comprises use of the search interface as described in FIG. 1, and then the corresponding use of the additional elements in the corresponding way, to play the result clips in any desired order, refine the search, and perform new searches.

Some embodiments additionally comprise a system and method for controlling and tracking revenue, and selling of advertisement and promotion related to the use of the information retrieval systems described herein, in accordance with an embodiment of the present invention. In particular, as described in U.S. patent application Ser. No. 11/230,949, advertisements can be promoted based on their relationship to the content being searched. Related is the fact that the present invention enables the promotion of music directly through the sound of the music. Some embodiments of the present invention in this regard are comprised of a database disposed to receive, store, and serve information about an amount paid or too be paid for the promotion of a particular song (or artist, or for any of the songs from a collection, etc.). Optionally, the database can be additionally comprised of information about the closeness of a match that will be paid for, or even an amount that will be paid by an advertisement provider, for an ad to be displayed, as a function of the degree of matching between a sound or clip associated with the advertisement and the sound of the query clip. All of this can be optionally in addition to matching based on, for example, metadata such as artist, genre, titles, etc, either from the query clip or the result clips or tracks, or both. In some such embodiments, a real-time auction of ad space is conducted, wherein the various information items just described are used to compute the best advertisements and their order of placement in an advertising section on the website described herein. Embodiments of this are further described in U.S. patent application Ser. No. 11/230,949. In addition to or instead of the placement of advertisements within an advertisement section, such methods can also be used in the same way, in accordance with the present invention as disclosed herein, to influence the placement of a particular track or set of tracks within a query search result set.

In some embodiments of the present invention, users provide feedback to a query by rating at least some of the results of the query, and this additional rating information is then used to re-order the query results or to re-run the search query with this new information to influence the metric of closeness, for example in accordance with the methods described in patent application Ser. No. 11/230,949.

A particular aspect of the present invention in this regard relates to the automated or assisted refinement of queries by using the results of a first query, computing statistics on metadata and other features from the set of results of this first query, and using these results to create a refined query in the style of the fr_matr_bin algorithms described in U.S. patent application Ser. No. 11/230,949. With regard to the present invention, additionally this query refinement information can be presented to the user as a characterization of the clip, with an interface that allows the user to select elements of this characterization to refine the query. For example, if the results of a query are 80% within the genre of jazz, and 10% rock, with several hits by a particular artist, the system can ask the user if he would like to search for jazz results that are close to the query clip, or results by the artist in question. One of skill in the art will readily see how to expand on this idea to create various interfaces that allow for computer assisted query refinement as described. In a similar way, the rank ordering and selections of tracks can be tuned by the user by adjusting the relative importance of features, say, emphasizing spectral features or concentrating on temporal beat. This can be achieved by tracking the users selection and changing the similarity measure or by having the user actively use an interface element such as a slider. In these cases, a way of tuning the searches to these different purposes is comprised of adjusting the similarity measure as disclosed.

Other embodiments of the present invention relate to using the music recommendation system disclosed herein as part of a game. Such embodiments comprise a set of game rules and other game materials standard in the art of games, such as but not limited to game board(s), game pieces, game cards and the like, and wherein the game play involves in part an associating between certain game elements and certain music or features of certain music in the music library of the present invention. Game play includes the step of at least some players using the music recommendation system disclosed herein to perform a music search in accordance with the rules of the game, and use at least one of the results returned in order to influence game play.

One example comprises a musical racing game played by a player and an opponent. Game play comprises the opponent picking a challenge: the player is to start with a seed song or genre or artist (say, “Enya”), and a (typically very different) target song or genre or artist (say “Metallica”). The player's goal is to try to jump from the seed to the target through music recommendations generated by the system, so the player:
1) Picks a starting seed song according to the opponents challenge
2) Gets some recommendations from the system, for the current seed song
3) Picks a new seed song from the system-generated recommendation list. (typically one that player thinks is “closer” to the target, but maybe one that the player wants to pick for any other reason)
4) Loops to 2 until player arrives at the target in the result list, or gives up, or runs out of time (i.e., in some embodiments there is a predetermined time to complete the task; in others, say, a predetermined maximum number of moves allowed).

Player's score for the round is from a predetermined formula, such as 10 minus the number of iterations that it takes to get from seed to target.

Of course this is but one example, and many others are possible. For example, but in no way limited to this example, a game can consist of a variant of the game of Monopoly wherein, among other adaptations, the concepts of cities and real-estate are replaced by the concepts of genres and artists. Other elements of the game are adapted to the music industry in similar ways. Game play proceeds by music recommendation events as described herein instead of the rolling of a die. Players buy and sell the right to promote artists, and must pay each other when searches produce hits that contain artists owned by the other players. Some embodiments additionally comprise bonus points if player finds some new music that opponent likes, or if player comes across the “secret artist of the day”, etc.

In accordance with an embodiment of the present invention, the interplay between the social and entertainment aspects of a game are combined with one or more elements of the search, discovery and recommendation system disclosed herein and this combination provides the advantages that it encourages use of the system by being fun, thereby improving the user traffic of the system, and/or other aspects such as the socially/community contributed information content of the system including but not limited to the collaborative filtering data and other system usage data.

Another aspect of the present invention relates to so-called “music fingerprinting”. Music fingerprinting is the process of identifying music from an audio segment instance of the music, and can involve the identification of artist, title, genre, album, performance date or instance and other metadata, from algorithmically “listening” to the music. A music fingerprint in this regard is a data summary of the music or a segment of the music, from which the music can be uniquely identified as described. In one embodiment of the present invention, the music features described herein are used as a fingerprint of the music. Indeed, one finds that in practicing an embodiment of the search invention as disclosed herein, the music file from which the search query arises, when it happens to also be in the database/music library, is returned as the first/best result of the query.

In a music fingerprinting embodiment a user provides a first music clip and desires an identification of the source of this clip, or some metadata characterizing this source. Query sound features of the clip are passed to a search element, and a search is conducted as disclosed herein. The results of the search are used as proposed identifications of source the first music clip. In an embodiment, additional elements can include the presentation of just the first result, or a series of results, with or without numerical “confidence” scores derived in a straightforward way from the numerical elements disclosed herein (e.g., one can use the Euclidean inner product of feature vectors as a score). Additionally, a straight comparison can be conducted in a neighborhood of each of the resulting target clips within their corresponding full music files (e.g., via a local matched filter using the query clip as the filter), to produce an additional score of confidence or match. In an embodiment, optionally, a result can be returned only if this score is greater than a pre-determined threshold.

In some such embodiments as disclosed herein, one can identify re-recordings of the same song (that aren't exact spectral matches) or recordings by different artists made in an attempt to sound exactly the same as some original recording. This is because the feature vectors in those cases will be quite close and typically closer than the feature vectors of any other songs.

Some embodiments of the present invention use tags or labels such as labels provided by users, to describe clips. Such embodiments comprise one or more interface elements allowing users to specify tags associated with a clip, to specify tags to be used as queries for searches, or to augment queries, and a database for storing and retrieving the tags and linking the tags with the associated clips. These tags can then be used as additional feature data in any of the embodiments described herein.

In accordance with an embodiment of the present invention a system and method is provided allowing a user to search for lyrics within music, and more particularly to search for the offset of a given textually specified lyric(s) into a segment of digital audio known or believed to contain the corresponding sung, spoken, voiced or otherwise uttered lyric(s). The present system comprises a search query specification element (1000), a song or song database element (1010), a search element (1020), a controlling element (1030) and a result presenting element (1040). A user enters a query with the query specification element (1000), the query comprising one or more words of text. The controller receives this query request and causes the search element (1020) to search the database element (1010), to find one or more results which are then presented by the result presenting element (1040). A result comprises the specification of a segment of digital audio, together with a time offset t, such that at approximately the time “t” within the audio segment, the lyrics corresponding to the search query are uttered, according to the search algorithm within (1020).

In an embodiment, the controlling element (1030) comprises a client-server Internet application, comprising one or more client applications (i.e., including but not limited to computer programs, scripts, web pages, java code, javascript, ajax and the like), and one or more server applications. The query specification element (1000) comprises a text entry field on a webpage served by the server and rendered by the client of the controlling element (1030). The database (1010) comprises a set of digital audio segments, and a set of corresponding lyrics files. The audio segments are, for example, audio recordings of performed music. The lyrics files contain the text of the lyrics of the songs in the corresponding music files, but they do not necessarily have a priori information about the precise or approximate time-offset within the music, at which any given lyric is uttered (although in some embodiments, such information is also in the database and can be used to generate or augment the search results). The search element (1020) comprises database access components, and an algorithm or collection of algorithms for finding the offset of lyric utterance given the target lyric(s), a music file, and a lyrics file containing the target lyric(s). The controller (1030) then looks up those songs in the database for which the target lyric(s) is contained in the corresponding lyrics-file, and feeds at least some of the results into the search element (1020) to determine the approximate offset. An example of an algorithm for the search element (1020) is to simply guess the middle of the song. In this way, the system simply indicates the presence of the lyric(s) within the song. A more precise algorithm is one that takes the offset of the target lyrics within the lyrics-file, and maps this linearly onto an offset of the corresponding audio segment, to find an approximate offset of target lyric utterance within the audio file. Another algorithm comprises the automatic detection of those segments of the audio file that contain speech, singing or utterances (collectively “speech segments”). Offsets into the lyrics-file can then be mapped linearly in time onto the speech segments of the audio file. Another algorithm, as disclosed in more detail herein, comprises the formation of a similarity matrix for the lyrics and a similarity matrix for the audio file (or the speech segments sub portion of the audio segment), and the alignment of these two structures in order to get a more precise alignment of the lyrics-file text with the utterances within the audio-file. The result presentation element (1040) can comprise a list of one or more result clips with offsets, and/or a sequence of short audio clips.

In accordance with an embodiment of the present invention, a user types a word or phrase into a search box, and receives one or more short audio clips containing the word (together with relevant meta-information so that the user will know from which audio pieces the corresponding clips were taken, perhaps how to buy the songs, etc.).

Turning now to a detailed description of an algorithm for the search element (1120) in accordance with an embodiment of the present invention, one such algorithm comprises the formation of a similarity matrix for the lyrics and a similarity matrix for the audio file (or the speech segments sub-portion of the audio segment), and the alignment of these two structures in order to get a more precise alignment of the lyrics-file text with the utterances within the audio-file. Exemplary algorithms are shown herein in pseudo-code. (note that the “%” symbol is used to denote the beginning of a comment within the code below).

```
                Function:  M_i,j  =  Sound_Similarity_Matrix(  audio_file,  win_step,
win_len)
Inputs:
        audio_file := source audio file to search (or an index or pointer to such a file)
        win_step := window step size for the similarity computation
        win_len := the length of a window for the similarity computation
Output:
        M_i,j := a similarity matrix for audio_file
Algorithm:
```

| | |
|---|---|
| 1) | let audio_1 = pre_process( audio_file) % (in one embodiment, pre_process does |
| | nothing and simply returns the whole file; in another embodiment, pre_process |
| | filters audio_file and returns only that portion of audio_file that corresponds to |
| | speech segments, with the intervening portions removed.) |
| 2) | i=0 |
| 3) | for win_off = 0 ... length( audio_1) - win_len, in steps of win_step |
| 4) | win = extract_window( audio_1, win_off, win_len) |
| 5) | feat_i = get_features(win) % these can be, e.g., FFT, MFCC, cepstral, temporal |
| | samples (i.e., the identity function) or filtered sub-samples, just to name a few, others |
| | are possible |
| 6) | i = i + 1 |
| 7) | end of for loop from line 3 |
| 8) | i_max = i |
| 9) | for i,j = 0... i_max−1 |
| 10) | Compute M_i,j = similarity( feat_i, feat_j) % similarity can be, e.g., inner product or |
| | any other similarity measure |
| 11) | end of for loop from line 9 |

```
                Function: M1_i,j = Word_Similarity_Matrix( lyrics_file)
Inputs:
        lyrics_file := textual lyrics file for the lyrics to audio_file
Output:
        M1_i,j := a similarity matrix for lyrics_file
Algorithm:
```

| | |
|---|---|
| 1) | for i,j = 0 ... length lyrics_file % length == # of words in the file |
| 2) | Let M1_i,j Word_Simlarity( lyrics_file.word(i), lyrics_file.word(j)) |
| 3) | End of loop from line 1 |

```
                Function:  Get_Lyrics_Offset(target,  audio_file,  lyrics_file,  win_step,
win_size)
Inputs:
        target := A target word or phrase
        audio_file := source audio file to search (or an index or pointer to such a file)
        lyrics_file := textual lyrics file for the lyrics to audio_file
        win_step := window step size for the similarity computation
        win_len := the length of a window for the similarity computation
Output:
        Offset := one ore more offsets into audio_file, approximately where the lyrics are
        believed to be uttered
Algorithm:
```

| | |
|---|---|
| 1) | Let Offset_List = [ ]; |
| 2) | Let M_i,j = Sound_Similarity_Matrix( audio_file, win_step, win_len) |
| 3) | Let M1_i,j = Word_Similarity_Matrix( lyrics_file) |
| 4) | For each occurrence of target in lyrics_file: |
| 5) | For word = each of the words around target |
| 6) | Let V = M1_word,: |
| 7) | Select those rows of M most similar to V and associate these to word |
| 8) | End of loop starting at line 5 |
| 9) | Chose a subset of the selections in line 7 to produce a nearly consecutive progression |
| | of selected rows, one row for each word in the loop from 5-8 |
| 10) | Append the offset of the first row in the subset from line 9, to Offset_List |
| 11) | End of loop starting at line 4 |
| 12) | Return Offset == Offset_List |

It is appreciated that the similarity in line 7 of the above algorithm associated with Get-Lyrics.offset function can be measured, for example, by resealing the two rows to have the same length and comparing the offset and repeat patterns of the peaks in the rescaled rows.

Regarding locating singing voice segments within music signals, there is a body of literature available to one of skill in the art. See, for example, the paper “Locating Singing Voice Segments Within Music Signals” by Adam L. Berenzweig and Daniel P. W. Ellis, available at http://www.ee.columbia.edu/˜dpwe/pubs/waspaa01-singing.pdf, and incorporate herein by reference in its entirety.

As described herein, in some embodiments a user or other source can provide additional information about the alignment between textual lyrics and utterances within an audio file. In an embodiment in this regards, the database can simply be augmented with pre-computed data on this alignment, and this can be used to conduct the searches described. In another embodiment, the methods and systems described herein are used to present a user with a first lyrics-to-utterance alignment. The user examines this alignment and listens to the corresponding audio files, and corrects the offsets. This corrected data is then entered into a database. The user can be the same as the user in the embodiments described elsewhere or another user.

In some embodiments, speech recognition algorithms are also used to align textual lyrics with audio utterances, as known to one of skill in the art, in combination with or instead of certain of the elements described herein.

Other algorithms can be used for the similarity alignment as described herein, including but not limited to those described in pending U.S. patent application Ser. No. 11/165,633, which is incorporated by reference in its entirety.

Some embodiments of the present invention are additionally comprised of relevance feedback mechanisms. Such an embodiment is comprised of a search or recommendation system as disclosed herein, and one or more mechanisms for measuring the user's reaction to the search recommendation results. Such mechanisms can be comprised of active interface elements, for example like the “thumbs up” and “thumbs down” interface on a standard TiVo remote control (see, for example, the TiVo Series2 DVR Viewers Guide, pages 8-9, in the section entitled “TiVo Suggestions”), or a rating on a scale of 1 to 10, or some other rating or feedback system known to one of skill in the art, and can also be comprised of passive relevance assessment elements such as the number of times or amount of time that a user listens to a particular result, information about the use of rewind, fast forward or skip buttons, use of or changes to the volume settings, and the like. Relevance assessment can be comprised of personal/individual information such as that relating to the user's prior choices, contents of the user's library, and the like, and relevance assessment can also be comprised of community data such as collaborative filtering data, methods and techniques. In an accordance with an embodiment of the present invention, a classifier such as those standard in the art including but not limited to those based on kernel methods, support vector machines, classification and regression trees, nearest neighbor classifiers and the like, and/or recommendation systems such as those additionally disclosed herein, is trained on a first set of data. A search or recommendation is performed in accordance with the present invention. The user is allowed to interact with the results to produce relevance information as disclosed herein. This relevance information is then used to re-train the classifier or relevance method. The search or recommendation results can then be re-ordered, and/or a new search or recommendation performed in accordance with the relevance modified data, and new results provided.

The present invention can additionally be used as an automatic seek button for looking for music on a digital radio, or as a method for creating playlists.

Certain embodiments of the present invention comprise systems for creating new music by mixing existing music, sounds, audio data, clips or samples. Such an embodiment comprises a search and/or recommendation engines as disclosed herein, as well as components for mixing returned results into a destination track. The process can be iterated while keeping a persistent destination track. Such an embodiment can comprise music mixing elements standard in the art including but not limited to slicing, fade-in, fade-out, special effects, echo, reverb, loudness adjustments, pitch adjustments, synchronization elements and the like.

An embodiment of the present invention comprises a method for finding similar users by measuring the similarity of the user's music collections in accordance with the methods disclosed herein. Additionally such a system can create a virtual merged music collection comprised of the results, collections and preferences of the two users, for example as a component in an online social networking website.

An embodiment of the present invention comprises a system for specifying a series of clips from one or more sources. Such a series will be called a multiclip herein. As described herein, a multiclip provides a way for a music search engine to learn a user's preferences and to conduct queries by allowing users to identify select and search on regions of auditory interest within a music, audio file or media file from the user computer. In addition, a multiclip provides for a summary of a piece of music. In one embodiment, a multiclip is used to provide one or more clips sought to characterize the beginning, middle, and end of a piece of music. A search is then conducted in accordance with the present invention and the result provided to the user. The example of “beginning, middle and end” is one of many possible ways to use multiclips to characterize or summarize music/audio/sound. In another such example, each sound in a library is automatically summarized using techniques known to those of skill in the art. Such techniques include but are not limited to identifying representative clips by forming a similarity matrix from the collection of segments of the sound at a given timescale (or at a plurality of timescales), and then taking the representative clips to correspond to regions of support of the top few eigenvectors of the similarity matrix. In this way, for example, each piece of music in a library of music may be summarized by a multiclip comprising a few clips within the piece of music, together with the order of occurrence or the location of occurrence of the clips. When a seed multiclip is used to search the database, the multiclip is scored against the multiclip summaries just described, to find matching tracks. One of skill in the art will readily see that these are but a few ways that multiclips can be used in accordance with the present invention and there are many others.

Some embodiments of the present invention are comprised of components for advertising. The advertisements are stored in a database and are rendered in response to advertising opportunities as disclosed herein.

In accordance with an embodiment of the present invention, an advertising system comprises a music search, discovery, and/or recommendation service as described herein, a database of advertisements wherein the advertisements are associated with music features, and a web client server application as described, wherein the web client is comprised of a display comprising a music search section and an advertising section as shown in FIG. 1. When users conduct searches in the search section, corresponding search query data are sent to the server. The server returns search results in response to the query data as described herein. Additionally, the server searches through the advertisement database to find advertisements for which the associated musical features mentioned herein are also matches or similar to the search query features. Such features can include but are not limited to music features such as the spectral and temporal features described herein, as well as music metadata. The advertising results can be ordered in a number of ways including but not limited to according to the degree of match, according to a price to be paid for or an expected return on rendering the advertisement, or a combination of those elements. The server sends search results back to the client application and also sends advertising results back to the client application. The client renders the search results and the advertising results in their respective sections of the client application display area.

An embodiment of the present invention can comprise an advertising customer interface and advertising database analogous to similar systems known in the art and incorporating the elements described herein, and a system and method for the selection and rendering of advertisements in accordance with the present invention.

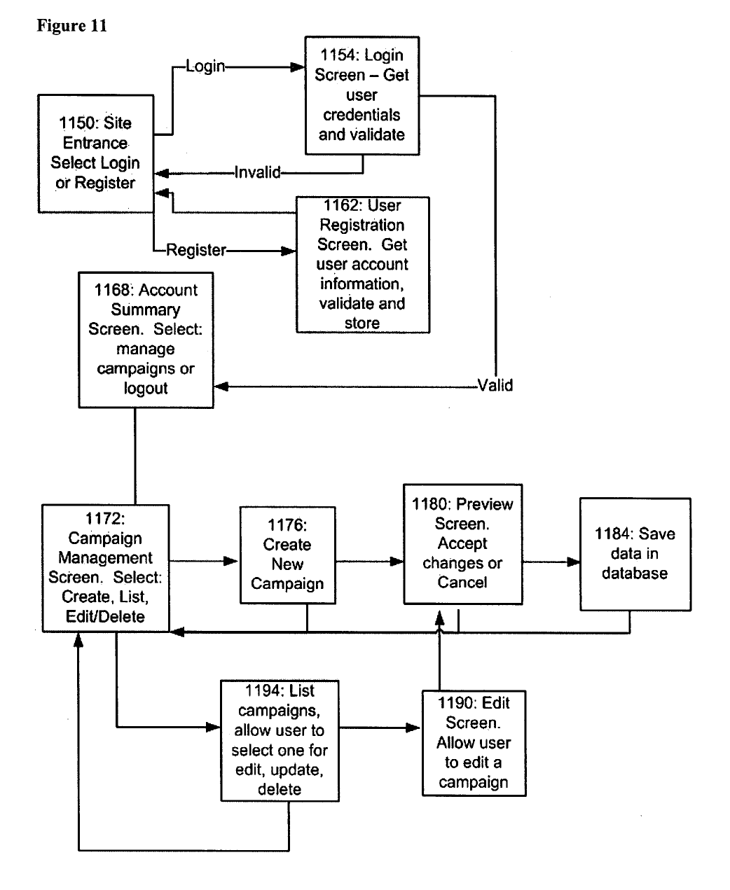

An advertising customer interface in accordance with an embodiment of the present invention comprises a customer interface such as but not limited to a web-based advertising customer client-server application. To distinguish this client-server application from the client-server application for music search, discovery and/or recommendation, both described herein, applicant will call the advertising customer client-server application the customer client-server application (and customer application, customer client, customer server, etc), and will call the music search and discovery application the end-user client-server application (and end-user application, end-user server, end-user client, etc). Such a customer application is illustrated by the block diagram in FIG. 11. As depicted in FIG. 11, the application has an entrance block (1150) by which a customer can choose to login to the system or register for an account. If, from the entrance block (1150), the user chooses to login, the login block (1154) gets the user's credentials, such as id and password, and tests for validity. If the credentials are valid control is passed to the account summary block (1168) and otherwise back to the login/registration block (1150). If, from the entrance block (1150), the user chooses to register for a new account, control is passed to the registration block (1162). The registration block collects user's account information such as contact first and last name, company name, identification of the set of music that the customer wishes to bid on, mailing and billing addresses and the like. This information is placed in the database for later activation. Once activated, an account is created for the user. After the information is collected and validated by the registration block (1162), control is passed back to the entrance block (1150). The account summary block (1168) displays welcome and summary information, such as but not limited to, the user's name and address, account balances, number of active advertising campaigns that the user has within the system, the number of impressions and clicks that the user's advertisements have received by use of the system, within the past accounting period, and other information about the account and account activity as dictated by the particulars of the application. From the account summary block (1168), the user may choose to manage advertising campaigns or logout. If the user selects logout, control is passed back to the entrance block (1150), and if the user selects to manage advertising campaigns, control is passed to the advertising campaigns management block (1172). The advertising campaigns management block (1172) displays detailed information about the set of advertising campaigns that the user has in the system as determined by the application, and provides for choices by which the use can create new campaigns, list/browser through and examine existing campaigns in detail, and modify, edit or delete existing campaigns. If a user selects to create a new campaign, control is passed to a campaign creation block (1176). The campaign creation block (1176) allows the user to view, search and navigate through the set of music tracks associated with the user, selecting some of those tracks for which the user wishes to place a bid, and specifying the bid amount(s). These selections are stored in a campaign object. When the user is satisfied with the campaign so created, the user selects an “ok” action and control is passed to the preview block (1180) where the user can review the choices just made and select “OK” in which case control is passed to a database entry block (1184) and the new/edited campaign is entered into the database, or cancel in which case no entry is made into the database. In either case control is then passed back to the management block (1172). At any time that the user can select cancel from blocks (1176) or (1180) and control is then passed back to the management block (1172). From the management block (1172) the user may also choose to list/browse the set of advertising campaigns that the user has within the system and control is passed to a campaign listing block (1194). From the block (1194) a user can examine individual campaigns in detail, and can choose to edit, update, revise or delete an individual campaign. On these latter choices control is passed to the editing block (1190) analogous to the create block (1176) but where the selection are pre-populated to the existing selected campaign. The user can edit the data associated with the campaign and then control is passed to the preview block (1180). In an embodiment, in addition to the specification of music tracks, campaign creation and editing can comprise the step of providing for the user to specify advertisement content in connection with the selected music tracks. In an embodiment the interface provides for the customer to specify, for each advertisement, associated music data than can include but is not limited to the specification of a music clip, the music sound features associated with that clip, and/or music metadata.

Note that the block diagram is meant to illustrate a particular embodiment and is not meant to be limiting. In particular, the individual functions and interface elements described need not be implemented as separate blocks or elements, and can be embodied, for example, in the logic and instructions of client/server code as server-side and client side scripts and programs.

An advertising database in accordance with an embodiment of the present invention is comprised of a database, the database being comprised of advertising customer information such as but not limited to contact name and address, login credentials such as user id and password, encrypted and made secure by methods known in the art, billing and other information, and a specification of which music is associated with the advertiser. The database is also comprised of the information for all bids entered into the system, and all advertising content and data associated with advertisements entered into the system and this can include but is not limited to specific URL/links that a user is to be sent to if the user clicks on the associated advertisement; image and/or text information for the display of the advertisement; and/or sound to be played when the advertisement or a “play button” portion thereof is clicked. In an embodiment each advertisement is associated with music data than can include but is not limited to the specification of a music clip, the music sound features associated with that clip, and/or music metadata.

An embodiment of the present invention displays advertisements in connection with music search, discovery and recommendation queries. To that end, the parameters that determine the query are used to additionally search through or score the music data associated with each advertisement. The advertisements are sorted a first time, according to the degree of match, and a certain number of advertisements are selected for display. These selected advertisements can be sorted a second time according to the bids associated with the advertisements. The advertisements are then passed from the server to the client in the enduser application, and are displayed by the enduser client application in the sorted order, for example in the advertising section (120) of the webpage illustrated in FIG. 1, and the corresponding area seen in FIG. 9. Note that in the first and second sortings, the value of the degree of match can be combined, for example by a weighed sum, with the bid amount, in order to sort by a combination of the degree of match and the bid amount.

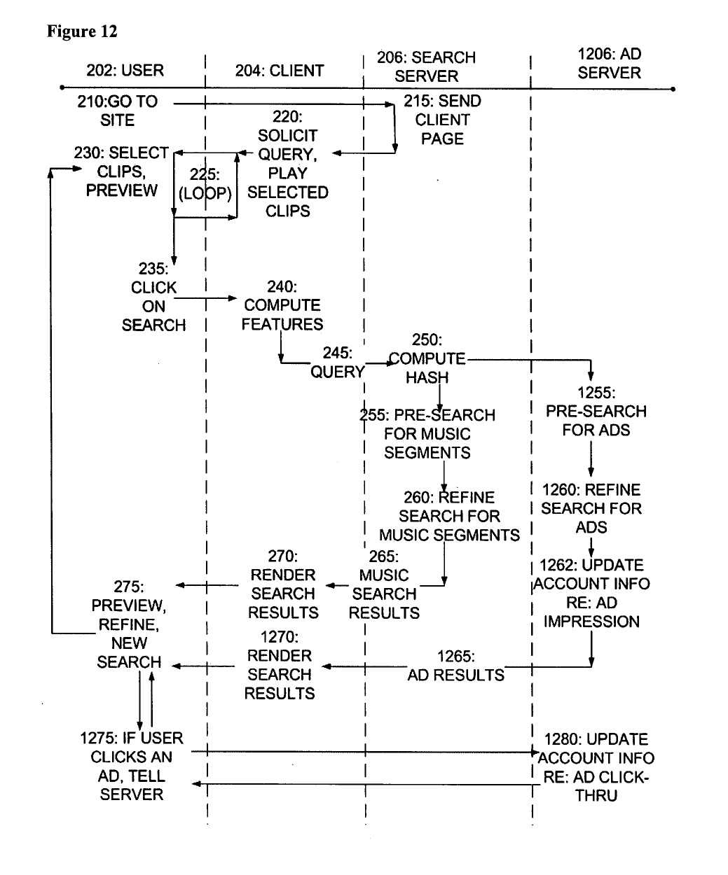

FIG. 12 shows such an embodiment, wherein the system and method searches for advertising as well as music. FIG. 12 reproduces the elements of FIG. 2 (with a few re-labeled to distinguish them from the elements shown in FIG. 12 that are not detailed in FIG. 2), and adds some elements to detail the advertising aspects of an embodiment of the present invention. The functioning of the new elements is analogous to the elements from FIG. 2, but directed towards the serving of advertisements in accordance with the present invention as opposed to the serving of music search, discovery and/or recommendation results, and is described in more detail herein.

Examples of uses of the system described herein for advertising include but are not limited to the following. In one kind of use, a music composer, artist, publisher or promoter, collectively a customer, wishes to promote a particular piece of music (the “track” herein). The customer uses the interface described in FIG. 11, for example by going to a website of a provider practicing an embodiment of the present invention, and the customer creates an account. The customer uploads or otherwise identifies the track. The system of the present invention inserts a reference to the track into the advertising database. When a search is conducted on a website in accordance with the present invention, as depicted in FIG. 12, when a search is conducted by a user that is similar to the track, the track is selected in the pre-search step (1255) and further selected in the refinement step (1260), the customer's account is updated to indicated that the advertisement was displayed to an end-user in step (1262), and advertisement is generated, which can include, for example and without limitation, images and text stored in the advertising database, and the advertisement is sent to the client application in step (1265). The advertisement in rendered by the client application in step (1270). As described in step (1275), if a user clicks on the advertisement, the client informs the server application (for example but not limited to by passing an XML message to the server), and in step (1280) the server updates the customer's account to reflect the fact that a click of the advertisement has happened, and can include other relevant statistics, for example but without limitation, the date and time of the click, and certain information that may optionally be known about the user such as age, gender, and location.

In another example, a customer wishes to promote a first track that is relatively unknown to the general public—for example but not limited to a new piece of music by an up-and-coming artist, and the customer wishes to have this first track associated with a second track, for example but not limited to the case that the second track is of a similar genre and/or style as the first track, and the second track is more popular and well known. In that case, the customer uses the system as described, providing the second track to the system in order to determine the music features to associate with the ad, and providing data about the first track in connection with the advertising content of the ad. The ad can include but is not limited to text, images and sounds associated with the first track, and can optionally include a statement that end-users who like the second track may wish to consider purchase of the first track.

While the foregoing has described and illustrated aspects of various embodiments of the present invention, those skilled in the art will recognize that alternative components and techniques, and/or combinations and permutations of the described components and techniques, can be substituted for, or added to, the embodiments described herein. It is intended, therefore, that the present invention not be defined by the specific embodiments described herein, but rather by the claims, which are intended to be construed in accordance with the well-settled principles of claim construction, including that: each claim should be given its broadest reasonable interpretation consistent with the specification; limitations should not be read from the specification or drawings into the claims; words in a claim should be given their plain, ordinary, and generic meaning, unless it is readily apparent from the specification that an unusual meaning was intended; an absence of the specific words “means for” connotes applicants' intent not to invoke 35 U.S.C. §112 (6) in construing the limitation; where the phrase “means for” precedes a data processing or manipulation “function,” it is intended that the resulting means-plus-function element be construed to cover any, and all, computer implementation(s) of the recited “function”; a claim that contains more than one computer-implemented means-plus-function element should not be construed to require that each means-plus-function element must be a structurally distinct entity (such as a particular piece of hardware or block of code); rather, such claim should be construed merely to require that the overall combination of hardware/firmware/software which implements the invention must, as a whole, implement at least the function(s) called for by the claim's means-plus-function element(s).

1. A computer based method for selecting and displaying advertisements, comprising the steps:
receiving an audio clip from a user;
computing musical features of said audio clip;
transmitting said musical features of said audio clip to a server; and
receiving a set of advertisements from said server determined to be relevant in the context of said audio clip by comparing said musical features of said audio clip to musical features stored in a database and associated with a plurality of advertisements stored in said database to find said set of advertisements from said database that is determined to be relevant in the context of said audio clip.

2. The computer based method of claim 1, wherein the step of receiving said audio clip comprises receiving an audio segment of a predetermined size from said user.

3. The computer based method of claim 2, further comprising the step of selecting said audio segment of said predetermined size from a music file by said user.

4. The computer based method of claim 1, wherein the step of receiving said set of advertisements from said server comprises the step of receiving said set of advertisements from said database determined to be relevant in the context of said audio clip by determining near matches between said musical features of said audio clip and said musical features stored in said database and associated with said plurality of advertisements stored in said database.

5. The computer based method of claim 1, wherein said musical features stored in said database comprises at least one of spectral musical features, temporal musical features and Mel-frequency cepstral coefficients (MFCC) features; and wherein the step of computing comprises computing said at least one of said spectral musical features, said temporal musical features and said MFCC features of said audio clip.

6. The computer based method of claim 1, wherein the step receiving said set of advertisements from said server comprises the step of receiving a set of advertisements from said server determined to be relevant to said audio clip by comparing said musical features of said audio clip to musical features associated with a plurality of advertisements stored in a database using a hash function.

7. The computer based method of claim 1, further comprising the step of receiving a tag descriptive of said audio clip from said user and storing said tag associated with said audio clip in said database.

8. The computer based method of claim 7, further comprising the step of searching said database based on said tag received from said user.

9. A system for selecting and displaying advertisements, comprising:
a client device, associated with a user and connected to a communications network, for receiving an audio clip from said user and computing musical features of said audio clip; and
a server for:
receiving said musical features of said audio clip from said client device over said communications network,
determining a set of advertisements to be relevant in the context of said audio clip by comparing said musical features of said audio clip to musical features stored in a database and associated with a plurality of advertisements stored in said database to find said set of advertisements from said database that is determined to be relevant in the context of said audio clip; and
transmitting said set of advertisements to said client device over said communications network.

10. The system of claim 9, wherein said client device is operable to receive an audio segment of a predetermined size from said user.

11. The system of claim 10, wherein said client device is operable to receive said audio segment of said predetermined size from a music file selected by said user.

12. The system of claim 9, wherein said server is operable to determine said set of advertisements by determining near matches between said musical features of said audio clip and said musical features stored in said database and associated with said plurality of advertisements stored in said database.

13. The system of claim 9, wherein said musical features stored in said database comprises at least one of spectral musical features, temporal musical features and Mel-frequency cepstral coefficients (MFCC) features; and wherein said client device is operable to compute said at least one of said spectral musical features, said temporal musical features and said MFCC features of said audio clip.

14. The system of claim 9, wherein said server is operable to compare said musical features of said audio clip to musical features associated with a plurality of advertisements stored in a database using a hash function.

15. The system of claim 9, wherein said client device is operable to receive a tag descriptive of said audio clip from said user; and wherein said server is operable to receive and store said tag associated with said audio clip in said database.

16. The system of claim 15, wherein said server is operable to search said database based on said tag received from said user.

17. A computer medium comprising a code for selecting and displaying advertisements, said code comprising instruction for:
receiving an audio clip from a user;
computing musical features of said audio clip;
transmitting said musical features of said audio clip to a server; and
receiving a set of advertisements from said server determined to be relevant in the context of said audio clip by comparing said musical features of said audio clip to musical features stored in a database and associated with a plurality of advertisements stored in said database to find said set of advertisements from said database that is determined to be relevant in the context of said audio clip.

18. The computer medium of claim 17, wherein said code further comprises instructions for receiving an audio segment of a predetermined size from said user.

19. The computer medium of claim 18, wherein said code further comprises instructions for selecting said audio segment of said predetermined size from a music file by said user.

20. The computer medium of claim 17, wherein said code further comprises instructions for receiving said set of advertisements from said database determined to be relevant in the context of said audio clip by determining near matches between said musical features of said audio clip and said musical features stored in said database and associated with said plurality of advertisements stored in said database.

21. The computer medium of claim 17, wherein said musical features stored in said database comprises at least one of spectral musical features, temporal musical features and Mel-frequency cepstral coefficients (MFCC) features; and wherein said code further comprises instructions for computing said at least one of said spectral musical features, said temporal musical features and said MFCC features of said audio clip.

22. The computer medium of claim 17, wherein said code further comprises instructions for receiving a set of advertisements from said server determined to be relevant to said audio clip by comparing said musical features of said audio clip to musical features associated with a plurality of advertisements stored in a database using a hash function.

23. The computer medium of claim 17, wherein said code further comprises instructions for receiving a tag descriptive of said audio clip from said user and storing said tag associated with said audio clip in said database.

24. The computer medium of claim 23, wherein said code further comprises instructions for searching said database based on said tag received from said user.
